(19) United States
(12) Patent Application Publication
(10) Pub. No.: US 2013/0086208 A1
(43) Pub. Date: Apr. 4, 2013

(54) Distributed Monitoring And Control System

(71) Applicant: Thomas Heine, Boca Raton, FL (US)

(72) Inventor: Thomas Heine, Boca Raton, FL (US)

(73) Assignee: ALJEX SOFTWARE, INC., Middlesex, NJ (US)

(21) Appl. No.: 13/337,115

(22) Filed: Dec. 24, 2011

Related U.S. Application Data
(60) Provisional application No. 61/542,088, filed on Sep. 30, 2011.

(51) Int. Cl. G06F 15/16

(52) U.S. Cl. 709/217

(57) ABSTRACT

A distributed computer system in which a central maintenance system communicates with a plurality of communication devices associated with remotely distributed equipment. The operator of each piece of remotely distributed equipment uses a communication device to communicate any problems related to the equipment, or other requirements such as the need for supplies. The communication devices can be notebook computers, tablet computers, smart phones, or any other suitable device. They communicate in real time with the central maintenance system. The information may include damage description, component descriptions, supply orders, as well as information regarding probable scheduling changes. The central maintenance system also has the capability to communicate instructions or requests for information to selected communication devices.

### CROSS-REFERENCE TO RELATED APPLICATIONS

This application is related to, and claims the benefit of, the provisional patent application entitled “Distributed Monitoring and Control System”, filed Dec. 30, 2011, bearing U.S. Ser. No. 61/542,088 and naming Thomas Heine, the named inventor herein, as sole inventor, the contents of which is specifically incorporated by reference herein in its entirety.

### BACKGROUND

1. Technical Field

This invention relates in general to a monitoring and control systems, and more particularly it relates to a distributed monitoring and control system for providing real-time bidirectional status information about widely geographically distributed assets, such as transportation equipment, or for inspecting local items such as factory equipment, damage to premises or facilities after unusual events such as hurricanes, floods, lightning damage, etc.

2. Background of the Invention

The transportation systems industry, like many other industries, has produced many large entities. The transportation industry uses many types of equipment, including vehicles, trucks, trains, containers, ships, and aircraft. When managing large numbers of equipment, the business can be adversely affected when problems associated with a piece of equipment is not known until the equipment arrives at its next location. If the equipment needs repairs, lack of knowledge concerning the problem may cause delays in obtaining parts or arranging for the appropriate personnel to be available to make the repairs. It would be desirable for businesses managing geographically distributed equipment to have real-time information related to the status of each piece of equipment such that maintenance and repair activities could be arranged as soon as a problem is encountered, rather than waiting for the equipment to arrive at the next location or the central maintenance location.

Large-scale trucking firms, such as moving firms or package delivery systems, typically have trucks distributed over wide geographic areas. However, most often these firms have only a few maintenance centers, sometimes only one. As drivers leave one location for another, they may inspect vehicles for damage or necessary repair work. Unfortunately, the maintenance center may not be aware of the problem until the driver arrives at the maintenance center. Without the advance knowledge of any problems, the maintenance center may not have any necessary parts in stock. In turn, this may cause the truck to be taken out of use until parts arrive. It would be desirable to have a method of providing real-time notice to a central location concerning any maintenance or other problem related to a particular vehicle such that the parts and supplies can be ordered prior to arrival of the vehicle so that maintenance is not delayed. In addition to maintenance, it would be desirable to monitor the status of equipment as it changes hands during normal operation. For quality control purposes, the invention is useful as a means to record the status of equipment during the day so that any damage can be associated with those using the equipment when it was damaged.

A similar application is in the area of rental cars or equipment. The system allows a rental car of other rental item to be inspected at the time of return to make sure that any damage is billed to the correct renter.

The same situation occurs with railroad systems. Individual firms may have thousands of rail cars distributed over the entire country. There is in ongoing need to provide quick maintenance for any problems associated with a railroad car, or locomotive, so that the individual car or locomotive can be rapidly returned to productive use. Real-time communications for the rail industry can be very important because some parts may take a long lead-time to obtain. As a result, the ability to quickly communicate with the maintenance location is important and desirable.

Another area of interest is air transport. While some problems necessitate rounding out the aircraft so it cannot get to a particular maintenance location, there are many components of an aircraft, particularly commercial aircraft, which will not prevent the aircraft from traveling to a central maintenance location. For example, things such as a broken passenger seat, problems with the air-conditioning, etc., will allow the aircraft to safely fly. Since the commercial aircraft industry relies on quick turnaround time to keep aircraft in the air where they can be productive, the ability to notify maintenance centers in real time improves the ability to have the aircraft available as much as possible.

The shipping industry is another example of an industry that has many pieces of equipment spread over wide of geographic areas. Due to the nature of this industry, communications with a central maintenance location can be even more difficult. Likewise, ships may have very specialized that may be obtained only from other remote areas. In this case, it would be desirable to have the ability to notify the maintenance center in real-time such that any remotely located parts can be ordered well before the ship arrives at the maintenance center.

Rental automobile fleets are another example of widely distributed which requires maintenance and repair on a frequent basis. It would be desirable to have a system that would allow an individual driver to notify a maintenance center prior to bringing a particular automobile in.

In addition to transportation systems of various types, there are other types of equipment, such as large factory environments, in which a real-time communication system would be valuable as an aid in rapidly obtaining supplies or maintenance assistance.

In addition to monitoring equipment distributed over wide areas, the invention can also be used for a variety of local applications. For example, it can be used in factory environments to monitor equipment and problems throughout a factory. Local events such as storms, hurricanes, tornadoes and floods produce significant workloads for both repair personnel and for financial personnel such as insurance agents. Those engaged in repair work can quickly create a list of items that need repair and forward the list to a central location where supplies can be ordered and repair personnel can be scheduled. Likewise, individuals such as insurance agents can more rapidly record damage to property, including acquisition of text, voice and/or video/photographs, that will more accurately and more rapidly settle claims.

While the prior art has provided basic maintenance facilities for a variety of industries and applications, it has failed to provide a convenient, portable communication system that would provide relevant information to central maintenance facilities such that components and personnel would be scheduled and available when the vehicle or equipment arrives at the maintenance facility.

### SUMMARY OF THE INVENTION

This invention provides a distributed computer system in which a plurality of communication devices, such as tablet computers, smart phones, etc., communicate in real time with a central maintenance system that monitors equipment status over a wide area in real time. The operator of each communication device inputs equipment status information on a real-time basis. The information may include damage description, component descriptions, supply orders, as well as information regarding probable scheduling changes. Central computer also has the capability to communicate instructions or requests for information to selected communication devices. The system provides for text information, image information, video information, or audio information. Optionally, voice dictation software can be used to input text information.

### BRIEF DESCRIPTION OF THE DRAWINGS

FIG. 1 is a block diagram that provides an overview of the system.

FIG. 2 is a flowchart that illustrating operation of the system.

FIG. 3 is in illustration of a preferred embodiment of the screen of a communications device used to communicate with the central computer. This figure illustrates how the invention may be used in conjunction with the trucking industry.

FIG. 4 is an illustration of a preferred embodiment of the screen of the communications device that illustrates how segments of our trailer are defined.

FIG. 5 illustrates how a list of items is selected, and also illustrates a text entry field.

### DETAILED DESCRIPTION OF THE PREFERRED EMBODIMENT

Prior to a discussion of the figures, an overview of the invention will be presented. The invention is a real-time communication and control system that allows operators of equipment distributed over a wide geographic area to communicate with a central maintenance system or arrange for any maintenance or repair work that may be necessary prior to returning the equipment to a central repair location. In addition, the system allows two-way communications between the central computer and individual equipment operators to gather information or issue instructions.

In addition to a central computer, each operator would have a communications device that provides wireless communication with the central computer. The communications devices can vary from one operator to another. For example, tablet computers such as laptop computers, the iPad™, the iPhone™, or similar devices can be used as a communications device. Those skilled in the art will recognize that the foregoing list of communication devices is exemplary only, due to the large number of commercially available devices manufactured by numerous companies. In particular, any smart phone, tablet computer, or similar intelligent portable device can be used. The development of this technology has allowed companies to provide employees with relatively expensive you powerful technology. While it is possible to structure a system using only a single communication device, the preferred embodiment envisions a system that is not limited to one specific type of communication device.

While the system is primarily intended for use with the trucking and/or transportation industries, those skilled in the art will recognize that it can be modified for use with other industries and other types of equipment. It is not intended that the system be limited to monitoring and controlling a single type of equipment. For example, package delivery systems, such as FedEx™, DHL™, and the U.S. Postal Service employee many different types of equipment. These firms ship packages locally via small delivery trucks, and/or they ship interstate via large trailer trucks, via airplane, or via rail. A large carrier, such as those mentioned, would be best served by a system capable of concurrently managing multiple types of equipment or vehicles. Currently, there is no bidirectional control and monitoring system that provides real-time communication, and remotely delivered information to facilitate rapid turnaround, or to provide real-time notice of any problems or concerns related to remotely located equipment. The invention disclosed therein provides just such a system

In regard to uses of the system related to trucking and transportation, and also to other industries, the system provides the following advantages.

In regard to the trucking and transportation industries, the invention provides a very efficient method of healing pre-inspection routine prior to authorizing use of a vehicle. This can include a program checklist to ensure that the vehicle is in proper condition for use. This would eliminate on road breakdowns by preventing vehicles from leaving without a proper inspection. Another advantage provided by the invention is that the communications device can have in its internal storage contracts, or have the capability of downloading contracts from a single site. This will ensure that all of the proper agreements have been executed prior to releasing the vehicle. The system also provides for delivery inspection not only how the vehicle itself, but also for inspection of cargo contained within. This will ensure that any damage to goods have been properly noted at the point of delivery. In addition, the government requires that specific mandatory safety inspection documents must travel with the vehicle. These documents can be stored on the communication device, and in addition, the communications device can be integrated with DOT and weigh stations to include things such as weight, seal number, manifest and approval for manifest if required state lines (i.e.; food, weapons).

In regard to the manufacturing industry, the communications device can be used in conjunction with fixed assets, manufacturing equipment, and finished goods. For fixed assets or manufacturing equipment, a communications device can be used to photograph each asset for use with annual audits (for property taxes returns, etc.), or asset tagging/identification. In the case of manufacturing equipment, communications device heads the additional benefit of scheduling repair and maintenance, or for parts orders. For cargo or finished goods, the communications device can be used to photograph items being transported. In addition, the photographs allow the customer to verify that they are receiving the correct item.

Another significant advantage provided by the system is that it can be integrated with existing business software products. For example, it can be used in conjunction with commercially available accounting, production, and maintenance software products. The communications device allows these software products that visual documentation. In the case of maintenance, a real-time visual record could reduce asset downtime by making maintenance more efficient. The images created by the invention can also be used to provide a record of defects for use by the engineering department. Likewise, the images can also be used to communicate status to customers. As a result, the images created by the communications device can be used by multiple software platforms within a company.

In regard to the car rental industry, rental cars or inventory that can only be used when they are satisfied safety standards. Rental cars can only be useful if the safety standards for those cars have been met. The ability to generate visual records of a rental car can aid in keeping the car in useful condition such that it can continue to produce revenue. During normal use, the rental car agent can walk around the rental car and photograph any damage. In addition, the rental of car agent can photograph other items, such as fuel gauge and the odometer so they can be compared to the vehicle when it is returned.

When vehicles are purchased, the communications device can be used to provide information related to the history of a vehicle, including vehicle damage. Likewise, as rental cars move around the country, the communications device provides the ability to have all records related to maintenance.

In regard to the Shipment of Goods, the communications device can create and maintain a visual record of the container, package, or trailer at the start of the trip, and at checkpoints along the trip. The ability to create a visual record and verify the condition of items within a container or package, as well as the condition of the trailer. This provides an advantage in that the communications device can transmit images of the contents to the entity receiving the goods. If the entity determines from images transmitted from the communications device that they will reject it should because of damage, etc., the shipper can save the expense of actually transporting the goods to the entity by unloading the trailer prior to transporting the goods. In addition, the shipping order, billing and transfer of ownership of the goods can be documented with a visual record.

In regard to ocean freight, the communications device can provide the manifest, applications, and/or acceptances, along with a visual record that in assist federal agents when goods are being imported. They can rapidly have access to all documents, and understand the nature of the cargo. Likewise, they can quickly determine if any documents are missing. As a result, freight moving through customs can be processed faster. Another advantage provided in this regard is that missing signatures can be rapidly secured via electronic transmission to facilitate movement of goods.

Another potential use for the invention is in the insurance adjustment and underwriting industry. Adjusters can not only make a visual record along with notes related to a claim, but they can also use optional features such as voice annotation in conjunction with video to create an accurate and complete record related to that claim. Visual records along with notes can also be used as input to the policy writing process to ensure that any inclusions or exclusions are properly documented and made. The purpose of writing an insurance policy, an individual can use a communications device to create visual records on an item or property that can be uploaded along with application data to the insurance company. The company would then have the option of running the policy based on the uploaded data, or determining that they need to have an on-site inspection.

In regard to the health industry, both the doctor and patient can input data that can be exchanged when treatment is needed. Likewise, hospitals can use the communications device to keep track of any maintenance or software revisions related to equipment used in the hospital. Emergency personnel can use the communications device to transmit information to the hospital so that emergency personnel at the hospital can be alerted and be ready when the patient arrives. Another medical application allows for communication device to be used by a physician during routine office visits to record visual data related to an individual patient. Physician's notes could be linked to a variety of applications. For example, prescriptions could be transmitted to pharmacies, and information can be transmitted to insurance companies and linked to benefit codes. In turn this allows an adjuster at the insurance company to have all data in one location such that it can be easily and quickly reviewed.

New technology, such as touch panel or computers (e.g., the iPad, etc.), smart phones such as the iPhone™, or other intelligent devices, provide an inexpensive way for equipment operators to access a central computer in real-time to inform them of any problems or issues related to a particular piece of equipment. In a preferred embodiment, the operator would use software in the communications equipment to display images of the equipment in question. The operator would then use the touch screen on the communications device to mark areas of the equipment that require attention or repair. In addition, the preferred embodiment allows the operator to add text annotations and/or audio information related to the images. Once the information is input to the communications device, the operator transmits information to a central computer. This can be done via a Wi-Fi network, or via other communications links, such as cellular phone connections.

The ability to upload information regarding equipment status in real-time provides the maintenance facility with advance notice of any issues or problems related to the equipment. In turn, the maintenance facility will schedule any components or service personnel such that they will be available when the quick turns for the maintenance facility. This allows it to be promptly repaired and returned to service with no unnecessary downtime. As a result, the equipment is used more productively and more profitably.

Other features that are commonly available in smart phones and tablet computers can enhance operation of the invention. For example, many of these devices have both clocks and GPS receivers. These features allow the invention to automatically record the time and place of any measurement or data recording. This makes the operation more efficient and also verifies that an inspection has been made at the appropriate place and/or time.

In the case of the trucking industry, the communication device can be used not only to alert the central system of any repair activity, but it can also be used to communicate other business relevant information, such as delays, emergency situations, etc. As a result, companies can take swift action to assist the equipment operator.

Container shipments can also be well served by the invention by allowing the operator to inform the company in real-time about any problems related to physical damage to the container, or other adverse situations such as theft or tampering with the container.

The rail industry will benefit in the same manner. The engineer or other individuals working on rail cars, or even locomotives, then use a communication device to alert the central maintenance system of any problems related to a rail car, locomotive, or even external factors such as rail or trestle damage.

In the case of aircraft, maintenance personnel can use a communication device to make note of any problems associated with the aircraft and communicate that information to a central maintenance system. In some cases, particular type of maintenance issues can prevent an aircraft from taking off the safety concerns. However, many maintenance items do not require aircraft to be grounded (e.g., a broken passenger seat, problem with air conditioning, etc.). In that case, the maintenance facility that the aircraft is heading to can be alerted to the fact that particular parts are required for the repair work. In addition to repair work, pilots using the tablet system disclosed herein can perform preflight checks and file flight plans. This provides the pilot with the benefit of being able to perform multiple functions with the same device, thereby eliminating the need to carry multiple devices.

The shipping industry and likewise benefit from the invention. In the case of the shipping industry, the device can be used to communicate not only with a remote central computer, but in addition, the device can be used onboard a single ship. In larger ships, such as a cruise ship, many hundreds of employees may be dispersed throughout the ship. The invention provides a convenient way for an employee in part of the ship to immediately communicate the need for service personnel or parts and/or supplies. As larger ships can run over 1000 feet in length, the use of this system even onboard single ship can greatly increase the efficiency of the people working on the ship by eliminating unnecessary delays and travel from one location to another.

Rental cars and taxi fleets our similar to the trucking industry in that large numbers of vehicles may be distributed across a wide geographic area. The invention provides a method for drivers to communicate in real time to a central location. In the case of write-downs for emergencies, the driver can notify the central system immediately. As is the case with all of the other foregoing embodiments, the software and the tablet will provide images of the vehicle that can be annotated via the touch screen to indicate where any problems exist.

All of the foregoing embodiments are discussed in terms of mobile equipment. However, the invention can also be useful for fixed location equipment, such as that found in factories. Modern industrial factories can have substantial size. For example, automobile assembly lines have been built which extend the quarter mile in length. A problem in any one point in an assembly line stops the entire production line for the factory. In that situation, there is a significant financial penalty for every minute the production line is down. A system such as that presented herein will be useful in limiting the amount of assembly line downtime.

An advantage provided by the invention is that it provides flexible control of one or more types of equipment, such as trucks, ships, aircraft, cars, etc. which may be used by a single company.

Having discussed the invention in general, we turn now to a detailed discussion of the drawings.

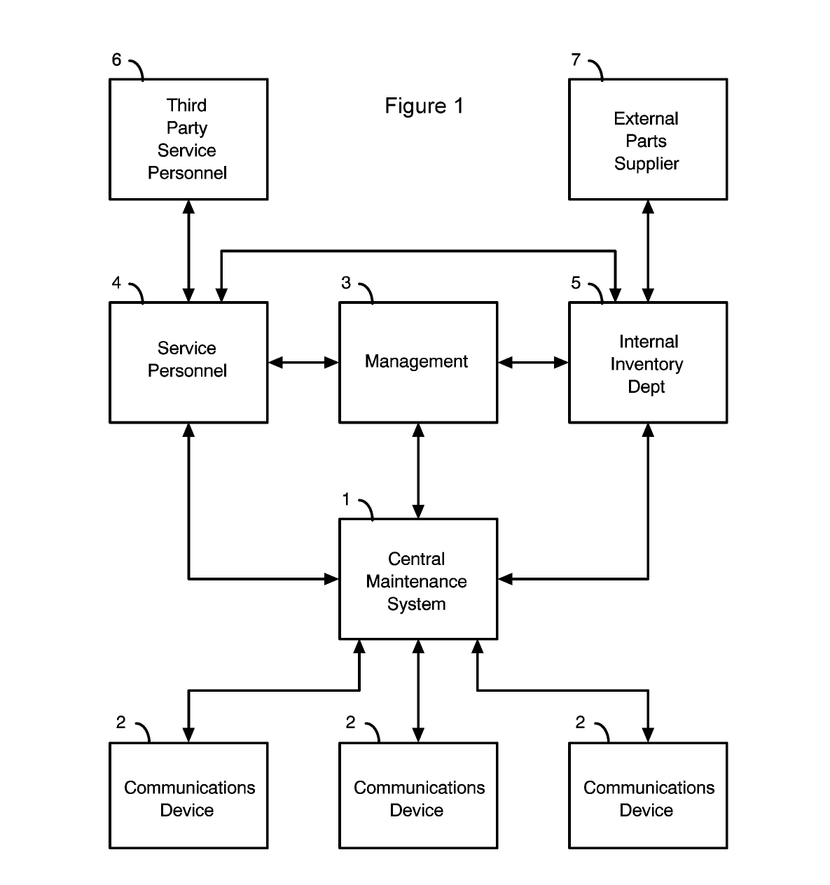

Regarding FIG. 1, FIG. 1 is a block diagram that provides an overview of the system. The heart of the system is the central maintenance system 1. The central maintenance system 1 is the point of contact for a plurality of communication devices 2. In the preferred embodiment, the communication devices 2 communicate with the central maintenance system 1 via wireless communications, such as a Wi-Fi network for a cellular phone network. This allows for communication devices 2 to be used in almost any location. Of course, those skilled in the art will recognize that a communications device 2 such as a tablet computer (e.g., iPad™, etc.) can also communicate via cable, modem, etc. when that facility is available. Those skilled in the art will recognize that while the preferred embodiment is based on a wireless system, the invention can also be implemented on fixed location computers such as PCs that are located at preselected locations in a factory, on a ship, etc., and communicate via the web or via a proprietary network.

When the central maintenance system 1 is notified by a communications device 2 that there is a problem, the central maintenance system 1 can then notify service personnel 4, the inventory department 5, or management 3 depending on the nature of the communication received from the communications device 2. Management 3 as the option of issuing instructions or making inquiries to service personnel 4 for the inventory department 5. In addition, the service personnel 4 and inventory department 5 can directly communicate based on the nature of the communication from the communications device 2. In the event that the service personnel 4 did not have sufficient expertise, they can communicate with third party service personnel 6. Likewise, inventory or 5 may contact external parts suppliers 7 in the event they do not have correct part in inventory. By using communication devices 2, each equipment operator can immediately notify the central maintenance system 1 such that repairs and/or maintenance can be immediately performed as soon as equipment arrives at either place maintenance location, or alternatively, arrives at the next destination that may have the capacity to effect repairs.

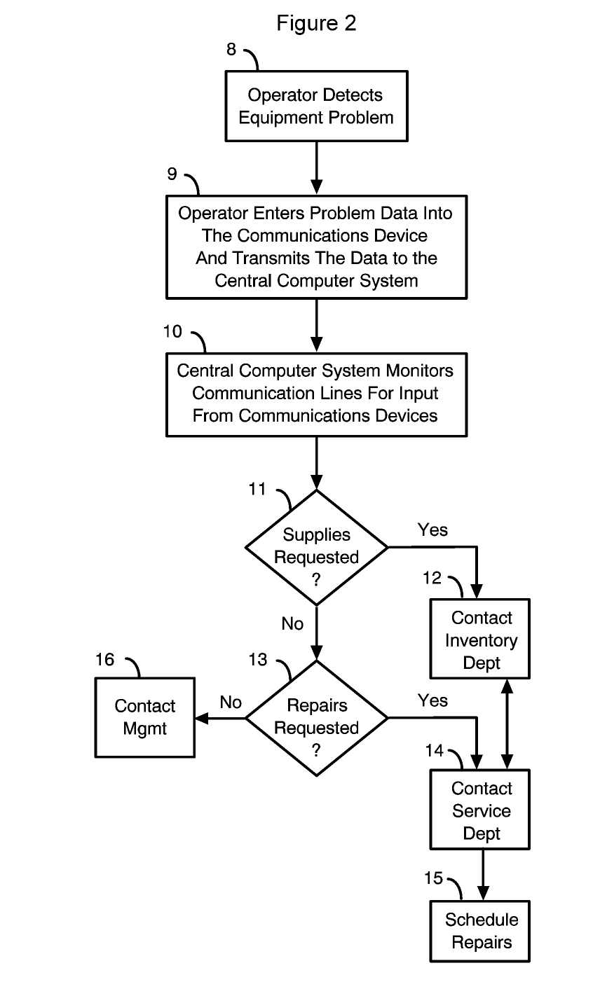

FIG. 2 is a flowchart that illustrating operation of the system. At step 8, equipment operator takes a problem or an issue related to the equipment. At step nine, the operator answers problem data into the communication device 2 and transmits the data to the central maintenance system 1. Data entry by the operator can be accomplished manually via a keyboard displayed on a touch panel screen, or preferably, verbally entered using a software voice dictation system that more efficiently generates text. Voice dictation software is well known in the art, and the portable devices used herein typically have integrated microphones.

At step 10, the central maintenance system 1 monitors for input data from communications devices 2. When an input is received from a communications device 2, the central maintenance system 1 determines if it is merely a request for supplies at step 11. If it is, then the inventory department is contacted by the central maintenance system 2 and the supplies are ordered at step 12. The inventory department may notify the service department if necessary at step 14. If the communications received from the communications device 2 is not a request for supplies, then the central maintenance system 1 determines if repairs are being requested at step 13. If so, the service department will be notified at step 14 and repairs will be scheduled at step 15. If the central maintenance system 1 determines that the communication is not a request for supplies, or requests for repairs, then management will be contacted at step 16 for appropriate action.

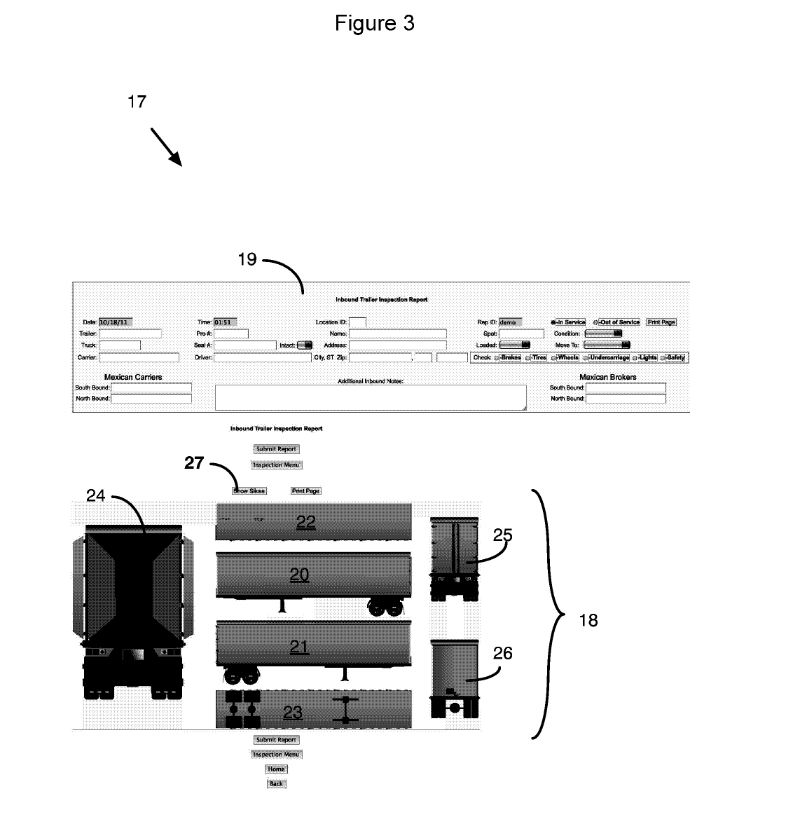

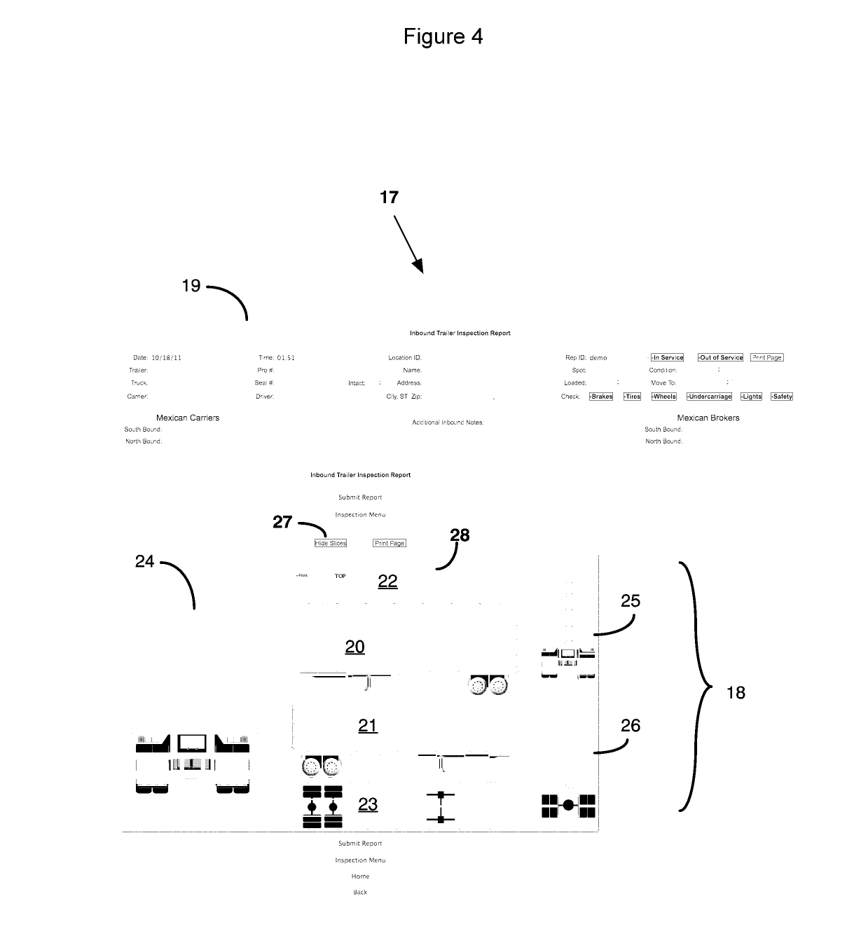

FIG. 3 is an illustration of a preferred embodiment of the display screen 17 of a communications device 2 used to communicate with the central maintenance system 1. This figure illustrates how the invention may be used in conjunction with the trucking industry. In this figure, multiple views of a truck 18 are illustrated. The display screen 17 illustrates various components of the truck 18, such as the trailer side panels 20-21, the trailer roof 22, the trailer underside 23, the trailer interior 24 (with the doors opened), the trailer end 25 (with the doors closed), and the trailer front 26. Also shown is “showing slices” button 27 (discussed more fully below in regard to FIG. 4).

FIG. 4 illustrates what happens when that showing slices button 27 is selected. Each portion of the trailer 18 is divided into sections 28. The operator would touch any section 28 which had a problem of some kind. As can be seen, any damage or problem related to any section of the trailer 8 can be identified on the display screen 17. The operator would merely tap on the relevant portion of the trailer 18 to identify which section 28 needed attention, or where the damage or problem is located.

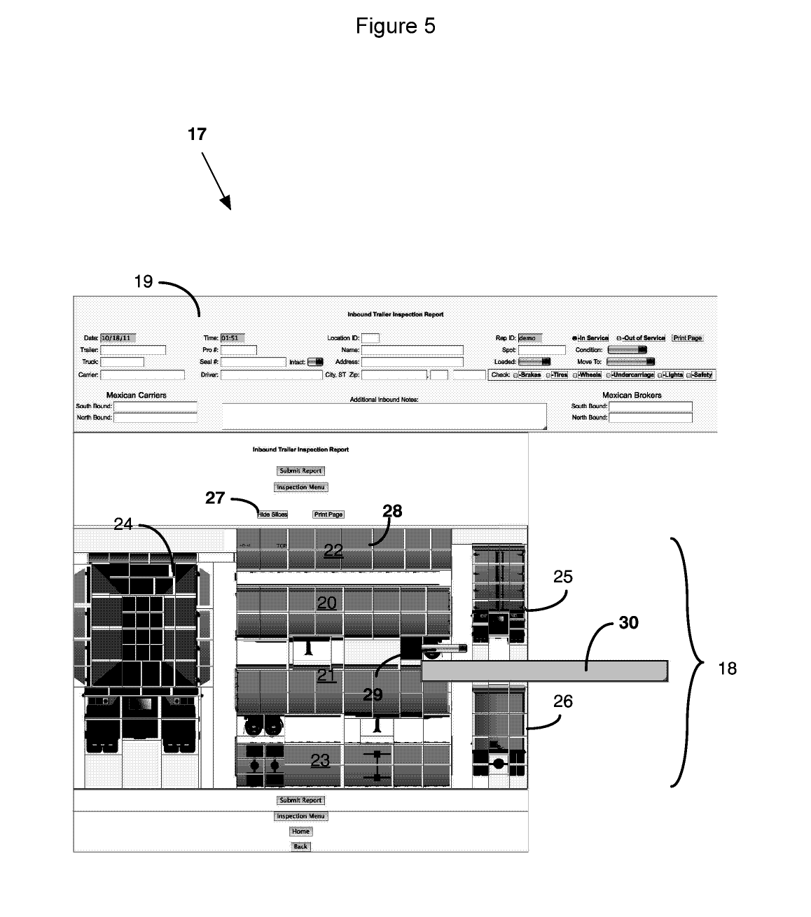

In FIG. 5, the item drop-down menu 29, and the text entry field 30 are shown. When the operator detects a problem of any sort, the item drop down menu 29 is activated in the list of potential work items are displayed. The operator then selects a particular work item. In this case a flat tire, and may also enter data in the text entry field 30. Alternatively, an audio input can be used to enter a verbal description of the problem. Once the operator has properly described the problem, the operator transmits the information to the central maintenance system 1.

In regard to container systems, the same process would be repeated with appropriate images representing different views of the container. The same applies on when the communications device 2 is used in conjunction with rental automobile and taxi fleet systems, rail systems, the aviation industry, the marine industry, manufacturing facilities, etc.

The foregoing embodiments have illustrated the advantages of the invention as a tool for providing equipment status to a central location. However, there are a significant amount of other applications that will be well served by the invention. For example: the invention provides the ability to click on a picture and have it present a list. This allows the user to tap on a location in the equipment and then be presented with a list of items specific to that portion of the equipment. The user can then select the pertinent items, or alternatively, enter freeform text.

The communications device 2 can be used to display an image of a truck, trailer, car, motorcycle, equipment, furniture item, or anything else that needs to be inspected and have it display the previous inspection information. The operator can then click or tap on the image and add more information items (e.g., broken, damaged, etc.).

A communication device 2, such as a tablet or smart phone can also be used to take a picture of the item and have it become part of the record. As the inspections and repairs are completed, each item comes off the damage list when that item is completed.

The communications device 2 is an excellent tool for trailer interchange, truck, trailer, car, motorcycle, or boat inspections. Further, it can be used by dot to document unsafe equipment, or by the Coast Guard to document unsafe ships. Other uses of the invention include use by a repair shops so that when a customer arrives, the service person could just tap on a picture of the car, truck, trailer, bicycle and mark in what items need to be repaired. Likewise, it could also be used by a medical office to obtain information related to a patient's health by clicking on a picture of the patient.

The invention can also be adapted for use in many situations that require information related not only to physical items, such as vehicles, but also to information related to actions. For example, in the case of a traffic accident, a police officer may tap on a computer screen to bring up a selection of intersection layouts. The officer could then lay out the position of vehicles involved in an accident to quickly create a record of what happened without the tedious process of drawing the intersection, position of vehicles, etc. As can be seen, the invention provides a significant amount of flexibility for use in a wide variety of situations where information is required, and where a predetermined set of information items can be listed for selection by the operator.

The foregoing embodiments have been discussed in terms of a communications device associated with an individual vehicle, automobile, ship, etc. Those skilled in the art will recognize that the communications devices can also be associated with a particular individual who may use different equipment items from time to time. The individual would alternatively specify the particular equipment item that is being monitored at the appropriate time.

While the invention has focused on a distributed processing system which uses a plurality computers, those skilled in the art will recognize that the system can be implemented on a single computer which allows the operator to simply tap on an image of a truck, car, or other equipment to select portions of that equipment for which notes will be made regarding repair work, maintenance etc. This can be used in a variety of locations, such as auto repair shops, etc. For example, a mechanic in an auto repair shop could click on an image of a vehicle that would then bring up a list of items related to that portion of the vehicle.

While specific embodiments have been discussed to illustrate the invention, it will be understood by those skilled in the art that variations in the embodiments can be made without departing from the spirit of the invention. The communications method may vary, the type of equipment may vary, etc. Therefore, the invention shall be limited solely to the scope of the claims.

I claim:

1. A remote monitoring and control system, comprising:
a central system having means to bidirectionally communicate with a plurality of remote communication devices;
a plurality of remote communications devices, each remote communications device associated with one or more selected items, and further having means to bidirectionally communicate data related to the selected item to the central system;
a touch panel screen in the remote communications device to display images of the selected item multiple viewpoints, the images of selected items segmented such that each segment relates to a preselected portion of the selected item;
means to enter data in the remote communications device that is related to the selected item based on information selected by touching portions of the touch panel screen, each portion of the touch panel screen associated with a selected portion of the equipment; and
means to transmit the data to the central system such that the central system can determine actions required for the item;
whereby the central system then initiate actions related to the selected item.

2. A system, as in claim 1, wherein:
remote communications device is a laptop computer, tablet computer or smart phone.

3. A system, as in claim 2, wherein:
the data entered into the remote communications device is text data.

4. A system, as in claim 3, wherein:
the data entered into the remote communications device is data related to maintenance, scheduling, equipment malfunction, and/or cargo information.

5. A system, as in claim 3, wherein:
the data entered into the remote communications device is data related to factory equipment.

6. A system, as in claim 3, wherein:
the data entered into the remote communications device is data related to insurance claims.

7. A system, as in claim 3, further comprising:
a drop-down menu having a list of text data entries; and
the data entered into the remote communications device is selected from the list of text data entries.

8. A system, as in claim 7, wherein:
the data entered into the remote communications device is data related to maintenance, scheduling, equipment malfunction, and/or cargo information.

9. A system, as in claim 3, wherein:
the data entered into the remote communications device is entered manually.

10. A system, as in claim 9, wherein:
the data entered into the remote communications device is data related to maintenance, scheduling, equipment malfunction, and/or cargo information.

11. A system, as in claim 3, wherein:
the data entered into the remote communications device is entered via voice to text software.

12. A system, as in claim 11, wherein:
the data entered into the remote communications device is data related to maintenance, scheduling, equipment malfunction, and/or cargo information.

13. A system, as in claim 3, wherein:
the data entered into the remote communications device further comprises audio, image, or video data.
